(19) United States
(12) Patent Application Publication
(10) Pub. No.: US 2021/0395522 A1
(43) Pub. Date: Dec. 23, 2021

(54) Reversible polymer binder for battery electrode applications

(71) Applicant: The Regents of the University of California, Oakland, CA (US)

(72) Inventors: Gao Liu, Piedmont, CA (US); Zhimeng Liu, El Cerrito, CA (US); Xin He, Albany, CA (US); Chen Fang, Kensington, CA (US); Yangzhi Zhao, El Cerrito, CA (US); Robert Kostecki, Lafayette, CA (US)

(21) Appl. No.: 17/322,807

(22) Filed: May 17, 2021

Related U.S. Application Data
(60) Provisional application No. 63/025,835, filed on May 15, 2020.

(51) Int. Cl. C08L 79/02; H01M 4/62; H01M 10/0525; H01M 10/36; C08L 33/02; C08K 5/00

(52) U.S. Cl. CPC C08L 79/02; H01M 4/622; H01M 10/0525; C08K 5/0025; C08L 33/02; C08K 5/005; H01M 10/36

(57) ABSTRACT

The present invention provides for a polymer composition comprising a carboxylic acid-containing polymer (CP) and an amino-containing polymer (AP). The CP and the AP are capable of crosslinking to each other through ionic interaction of the carboxylic acid and amino functional groups. The CP and the AP can be unlinked by increasing the pH of the polymer composition to about pH 13.

### CROSS-REFERENCE TO RELATED APPLICATIONS

This application claims priority to U.S. Provisional Patent Application Ser. No. 63/025,835, filed on May 15, 2020, which is hereby incorporated by reference.

### STATEMENT OF GOVERNMENTAL SUPPORT

The invention was made with government support under Contract Nos. DE-ACO2-05 CH₁₁₂₃₁ awarded by the U.S. Department of Energy. The government has certain rights in the invention.

### FIELD OF THE INVENTION

The present invention is in the field of polymer binders for lithium ion batteries.

### BACKGROUND OF THE INVENTION

In response to urgent appeal of shrinking urban air pollution from vehicles exhaust, the automotive industry is currently experiencing an energy revolution, with vehicles powered by gasoline transferring to transportations driven by electric power. During this decarbonization advancement, innovation of battery technology is pivotal since it plays an indispensable role in using more renewables and providing less expensive batteries while preserving high power density.^{[1]} Despite substantial progress made in battery technology, new challenges about management for end-of-life materials are posed as the number of electric vehicles has been steadily increasing.^{[2]} Therefore, to achieve further environmental soundness accompanying with increasing expansive utilization of electrifications, research attention needs to be paid in exploring sustainability of batteries, selecting chemistries that have a minimum footmark in nature and that are more easily recycled,^{[1,3]} a process that is pertinent to the development of future circular economy.

Among the various possible candidates of electrode materials, sulfur stands out as the most promising selection because of various advantages, including its natural abundance, cost-saving and superior theoretical capacity ((1675 mAh g⁻¹)) as well as energy density (2600 Wh kg⁻¹).^{[4-8]} These valuable advantages are highly desired for the development of next generation lithium batteries. Therefore, Li—S batteries have attracted a great amount of attention in recent years.^{[9-12]} Despite their promising properties, the practical application of Li—S batteries is still limited by the following issues: (1) the dissolution and diffusion of polysulfide intermediates (lithium polysulfide products, Li₂Sₙ, 4≤n≤8) in electrolyte,^{[13,14]} resulting in the loss of active sulfur on cathode and a low coulombic efficiency; (2) the poor electron and ionic conductivity of sulfur and sulfides, leading to the low utilization of sulfur and inferior rate capability;^{[15-17]} (3) large volume changes (about 78% of volume variation upon cycling), giving rise to the damage of integrity for electrode.^{[18,19]} These issues inevitably influence the performance of Li—S batteries, ultimately causing suppressed delivered capacity and fast capacity fading during cycling.^{[20,21]}

Tremendous efforts have been invested to address the issues mentioned above, which are mainly focused on construction of sophisticated cathode architectures. Usually, sulfur materials are infiltrated to conductive carbon hosts with various morphologies and microstructures. It has been reported that several types of carbon hosts, including hollow carbon,^{[22-24]} porous carbon,^{[25-27]} disordered carbon nanotubes,^{[28,29]} mesoporous carbon nanoparticles^{[30,31]} and double-shelled hollow carbon spheres,^{[32,33]} have made significant enhancement in delivering specific capacity and cycling stability of Li—S batteries. However, the preparation of these complicated carbon materials usually involves several complicated and energy-intensive steps,^{[34]} increasing the thermal budget and carbon footprint. Therefore, in order to reduce overall cost considerably, it is imperative to develop facile strategies to recycle the valuable carbon hosts at their end-of-life.

Another efficient strategy improving the electrochemical performance of Li—S batteries is to develop multi-functional binders which are capable of trapping the lithium polysulfides.^{[35-37]} As an essential ingredient of electrode composites, the binder is responsible for gluing the active material together with conductive additive on the current collector, and can maintain the integrity of electrode to ensure the electronic and ionic conductivity.^{[38,39]} However, the conventional poly(vinylidene fluoride) (PVdF) binder can only provide quite poor adhesion strength, which is hard to maintain integrity well for sulfur-based cathode due to huge volume variation during the lithiation/delithiation processes, causing the rapid capacity decay.^{[40,41]} Thus, polymers with polar groups to confine the dissolution of lithium polysulfides are urgently desirable. According to the previous reports, the crosslinked polymer with multiple functional groups can effectively mitigate the volume expansion and limit the shuttle of lithium polysulfides and, consequently, significantly improve performance of Li—S batteries, especially for high sulfur loading.^{[19,35,42,43]} For instance, Yan et al.,^{[44]} synthesized a new binder via co-polymerization of hexamethylene diisocyanate with polyethylenimine (PEI) to form a network structure with high proportion of amine groups. Moreover, the sulfur loading areal capacity can reach 7.9 mAh cm⁻², and the capacity retention is 91.3% over 600 cycles at 2 C. Similarly, Nazar's^{[45]} group prepared a stable high sulfur loading cathode by combining multifunctional sulfur composites with an in-situ cross-linked polymer binder, where the carboxymethyl cellulose was polymerized with small citric acid molecules in-situ formed a reticular structure through the dehydration condensation reaction and, as a consequence, crack free high sulfur loading electrodes (up to 14.9 mg cm⁻²) with high areal capacities (up to 14.7 mAh cm⁻²) and stable cycling life were obtained owing to the elastomeric cross-linked binder. Although the high mass loading and stable cycling sulfur electrode can be achieved by crosslinked polymers, most of them are unable to be dissolved in the solvent once they are polymerized. The valuable electrode materials in these designed electrodes are unable to be recycled through a simple method.

### SUMMARY OF THE INVENTION

The present invention provides for a polymer composition comprising a carboxylic acid-containing polymer (CP) and an amino-containing polymer (AP). In some embodiments, the polymer composition is a liquid or aqueous mixture, wherein the CP and the AP are not linked to each other. In some embodiments, the polymer composition is a dissolvable ionic crosslinked polymer (DICP) or a solid, wherein the CP and the AP are ionic crosslinked to each other.

The present invention provides for a dissolvable ionic crosslinked polymer (DICP) comprising a carboxylic acid-containing polymer (CP) and an amino-containing polymer (AP) ionic crosslinked to each other. In some embodiments, the DICP is a solid.

In some embodiments, the polymer composition of claim 1, wherein the CP and the AP are ionic crosslinked to each other. The crosslink is via a plurality of carboxylic acid function groups of one or more CPs ionic linked to a plurality of amino functional group of one or more the APs through carboxy-amino ionic interaction. The carboxy-amino ionic interaction is controlled by pH. Under more acidic conditions, the carboxylic acid functional group and the amino functional group are capable of forming a carboxy-amino ionic interaction. Under more basic conditions, the carboxylic acid functional group and the amino functional group unlink from each other and dissolve. In some embodiments, the ionic crosslinked CP and AP is a dissolvable ionic crosslinked polymer (DICP). In some embodiments, the AP comprises a plurality of monomers wherein each monomer comprises an amino functional group. In some embodiments, the AP does not contain any carboxylic acid functional group. In some embodiments, the AP does not contain any non-amino functional group. In some embodiments, the AP contains more amino function groups than other non-amino functional groups, such as carboxylic acid function group.

In some embodiments, the AP comprises the following chemical structure:

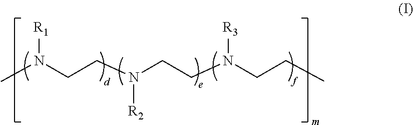

wherein R₁, R₂, and R₃ are each independently —H or —(CH₂)₂—NR₄R₅, wherein R₄ and R₅ are each independently —H, —(CH₂)₂—NH₂, or —(CH₂)₂—NR₄R₅; wherein the polymer chain can be terminated by —H, —(CH₂)₂—NH₂, or —(CH₂)₂—NR₄R₅; d+e+f=1; d, e, and f can be any number between 0 to 1; m is any number from about 10 or 100 to about 1000 or 10000; and. at least 1, 2, or 3 of R₁, R₂, and R₃ comprises a —NH₂ functional group.

In some embodiments, the AP is polyethyleneimine (PEI).

In some embodiments, the CP comprises a plurality of monomers wherein each monomer comprises a carboxylic acid functional group. In some embodiments, the CP does not contain any amino functional group. In some embodiments, the CP does not contain any non-carboxylic acid functional group. In some embodiments, the CP contains more carboxylic acid function groups than non-carboxylic acid functional groups, such as amino function group.

In some embodiments, the CP comprises the following chemical structure:

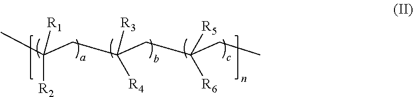

wherein R₁, R₂, R₃, R₄, R₅, and R₆ are each independently —H, —(CH₂)ₓ—CH₃, or —(CH₂)ₓ—COOH, wherein x is 0, 1, 2, 3, 4, or 5; wherein the polymer chain can be terminated by H or a functional group, such as a carboxylic acid; a+b+c=1; a, b, and c can be any number between 0 to 1; n is any number from about 10 or 100 to about 1000 or 10000; and. at least 1, 2, 3, 4, 5, or 6 of R₁, R₂, R₃, R₄, R₅, and R₆ comprises a —COOH functional group.

In some embodiments, the CP is a polyacrylic acid (PAA).

The present invention provides for a lithium ion or lithium-sulfur battery comprising a binder comprising the polymer composition of the present invention. In some embodiments, the polymer composition prevents or suppresses polysulfide dissolution in the electrolyte of a battery, such as a lithium ion or lithium-sulfur battery.

The present invention provides for a method of changing the state of the polymer composition of the present invention, the method comprising: (a) (i) introducing or adding a base to the polymer composition, wherein the AP and the CP are ionic crosslinked to other, to unlink the AP and the CP from each other, or (ii) introducing or adding an acid to the polymer composition, wherein the AP and the CP are not ionic crosslinked to each other, to crosslink the AP and the CP to each other.

In some embodiments, wherein method comprises the (a) (i) introducing step, and (b) introducing or adding an acid to the polymer composition to ionic crosslink the AP and the CP to each other.

In some embodiments, wherein method comprises the (a) (ii) introducing step, and (b) introducing or adding a base to the polymer composition to unlink the AP and the CP from each other.

In some embodiments, the (a) (i) introducing or adding a base to the polymer composition step comprises introducing or adding a base to the polymer composition to produce a solution having a pH of at least equal to greater than about 11, 12, or 13 to unlink the AP and CP. In some embodiments, the base is an alkali metal hydroxide, such as NaOH or KOH, or alkaline earth metal hydroxide, such as Ca(OH)₂, Mg(OH)₂, or Ba(OH)₂, or a mixture thereof. In some embodiments, the base is an aqueous solution.

In some embodiments, the (a) (ii) introducing or adding an acid to the polymer composition comprises introducing or adding an acid to the polymer composition to produce a solution having a pH of at least equal to less than about 7, 8, 9, 10, 11, or 12 to ionic crosslinked the AP and CP. In some embodiments, the acid is an inorganic acid, such as HCl, HNO₃, H₂SO₄, or organic acid, such as methanoic acid (formic acid), ethanoic acid (acetic acid), propanoic acid, malic acid, or a mixture thereof. In some embodiments, the acid is an aqueous solution.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1. (a) Synthesis scheme of dissolvable ionic crosslinked polymer (DICP) through carboxy-amino ionic interaction between polyacrylic acid (PAA) and polyethyleneimine (PEI); (b) Schematic diagram of DICP dissociated in the aqueous sodium hydroxide; (c) Photograph of DICP film; (d) and (e) Photographs of DICP film immersed in distilled water (pH=7) for 12 h and basic aqueous solution (pH=13) for 1 h, respectively; (f) Photograph of DICP film immersed in electrolyte (1.0 M LiTFSI in 1:1 (v/v) DOL/DME containing 1 wt % LiNO₃) for 12 h; (g) and (h) Photograph respectively shows the size of DICP film before and after being immersed in electrolyte for 12 h.

FIG. 2. Photographs illustrating the recycle processes of cycled lithium sulfur (a) Coin cell of Li—S batteries after 100 cycles at 0.1 C; (b) Sulfur electrodes obtained from cycled Li—S batteries; (c) Dispersed electrode materials in alkaline water (pH=13); (d) Recycled S/C composite obtained after washing (with distilled water)-centrifugation-drying. (e) Refilled S/C composite with 70 wt % sulfur content. (f) Reproduced sulfur electrode with sulfur loading of 5.5 mg cm⁻².

FIG. 3 (a) CV curves of sulfur electrodes with different binders at a scan rate of 0.1 mV s⁻¹ over the potential range of 1.7-2.8 V vs. Li/Li⁺; (b) discharge-charge curves of sulfur electrodes with different binders at 0.5 C; (c) Cycling performance of sulfur cathodes with different binders at current density of 0.5 C, sulfur loading 1.0 mg cm⁻² on aluminum foil; (d) Rate performance of sulfur electrodes with different binders, sulfur loading 1.0 mg cm⁻² on aluminum foil; (e) Cycling performance of sulfur cathodes with different binder, sulfur loading of 5.5 mg cm⁻² on nickel foam; (f) Cycling performance of sulfur cathode prepared from recycled carbon materials, with sulfur loading of 5.5 mg cm⁻² on nickel foam.

FIG. 4. (a) Schematic of the in-situ XAS experiment set-up; (b), (c) and (d) Discharge curve of in-situ batteries for S@PVdF, S@PAA and S@DICP, respectively. (e), (f) and (g) Selected in-situ XAS curves of S@PVdF, S@PAA and S@DICP cathodes, respectively.

FIG. 5. (a), (b) and (d) In-situ UV-vis absorbance spectra of the Li₂S₆-DME/DOL solutions after exposure to the different binder absorbers (PVdF-CB, PAA-CB and DICP-CB composite); Inserted photo is the vial of Li₂S₆-DME/DOL solution after exposure to the solution with corresponding binder absorber for 12 h. XPS S 2p spectra of lithium anode obtained after 10 cycles at 0.1 C: (d), (e) and (f) corresponding to the sulfur cathode using PVdF, PAA and DICP as binder, respectively.

FIG. 6. (a) Optimized structures of: lithium polysulfides (Li₂S₈, Li₂S₆ and Li₂S₄) and polymer fragments (PVdF, PAA, PEI and DICP). Arrows indicate the site/functional group where the polysulfides are initially placed to calculate their corresponding binding energies. (b) Calculated binding energies of lithium polysulfides (Li₂S₈, Li₂S₆ and Li₂S₄) with different polymer fragments in DME.

FIG. 7. FTIR spectra of PEI, PAA and DICP.

FIG. 8. TGA curve of recycled S/C composite.

FIG. 9. TGA curve of DICP.

FIG. 10. Surface SEM image of (a) S@DICP electrode, (b) S@PAA and (c) S@PVdF.

FIG. 11. Force-distance curves of sulfur electrode using different binders.

FIG. 12. The digital photographs of the electrodes after peeling tests.

FIG. 13. CV curves of pure DICP binder at a scan rate of 0.1 mV s⁻¹ over the potential range of 1.7-2.8 V vs. Li/Li⁺. The electrode is composed of the DICP binder and Denka black carbon with a mass ratio of 1:1.

FIG. 14. CV curves of pure S@DICP at a scan rate of 0.1 mV s⁻¹ over the potential range of 1.7-2.8 V vs. Li/Li⁺.

FIG. 15. Photos of Li₂S₆-DME/DOL solutions after exposure to the solution with blank, CB, PVdF-CB, PAA-CB, and DICP-CB composites.

### DETAILED DESCRIPTION OF THE INVENTION

Before the invention is described in detail, it is to be understood that, unless otherwise indicated, this invention is not limited to particular sequences, expression vectors, enzymes, host microorganisms, or processes, as such may vary. It is also to be understood that the terminology used herein is for purposes of describing particular embodiments only, and is not intended to be limiting.

In this specification and in the claims that follow, reference will be made to a number of terms that shall be defined to have the following meanings:

The terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

The term “about” when applied to a value, describes a value that includes up to 10% more than the value described, and up to 10% less than the value described.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

In some embodiments, the binder can be used in a sulfur electrode in lithium-sulfur rechargeable battery. In some embodiments, the binder is used in the negative and/or positive electrode of a lithium-ion battery or advanced lithium-ion battery.

In some embodiments, the binder is water soluble. In some embodiments, the binder can be solidified as a binder for a composite electrode. In some embodiments, the composite electrode can be dissolved again in a water solution by controlling the pH of the solution. This unique property of the binder enables design by recycling concept for batteries.

In some embodiments, the present invention allows commercial Si based materials to function properly in a commercial cell conditions, and addresses the most critical problems of both electrode mechanical degradation and electrode surface reactions of the Si materials.

The present invention provides for a class of polymer composition, which may be conductive, with side chain structures described herein suitable as electrode binders for Si, Sn and other alloy based composite electrodes. It also functions with carbon and graphite based materials. This class of polymer composition provides strong adhesion to the Si, Sn and carbon materials and Cu current collectors as an effective electrode binder. When the polymers are applied on surface of Si or graphite, the polymers in touch with the active materials (Si, Sn and Carbon) surface transforms into passivation layer during the electrochemical process to provide very strong passivation to the active materials surface. The ion pathway in the polymer binder due to the thermal decomposition of side chains provides ion transport. In some embodiments, it is preferentially to use this functional binder to cover the entire active materials particles surface to provide both strong adhesion and surface protection.

The same principle of electrode passivation and ion transport of this polymer can also be applied to lithium metal electrode protection. In this case, the functional polymers are used to protect the electrochemically deposited lithium metal against electrolyte and prevent both electrode and electrolyte side reaction and lithium dendrite formations.

Lithium ion and lithium metal battery companies and electric vehicle companies are most likely to use the invention. These companies can use this invention as one of the critical enabling materials and processes for their battery manufacturing process.

This class of functional conductive polymers has high electrochemical stability, excellent adhesion to the active material and electrode substrate and allows selective lithium ion transport to the active materials or collector substrate to ensure the overall integrity of the electrode system, and provide active material interface protection and passivation.

In some embodiments, the polymer compositions can be used as follows: (1) The polymer composition is coated on a surface of a current collector to form a composite laminate film. (2) The polymer composition can be coated on an active materials surface to form a coating and protective layer. The coated particles can be used as battery materials. (3) The polymer composition can be coated directly on a flat surface such as carbon, Si, Al, Li, or Sn film surface. (4) The usage can be for lithium, sodium battery, and Mg and/or Zn battery system. (5) The usage is not limited to battery application, but can be used to any application need to have ion or electron mobility.

### Example 1

### Reversible Crosslinked Polymer Binder for High Performance and Recyclable Lithium Sulfur Batteries

Grappling with diminishing negatively environmental impact associated with extensive utilization of batteries, sustainability of the cells needs to be included into systemic research of batteries. Herein, a dissolvable ionic crosslinked polymer (DICP) was exploited as binder for lithium-sulfur batteries by crosslinking the polyacrylic acid (PAA) and polyethyleneimine (PEI) through carboxy-amino ionic interaction. This interaction is pH controlled, and therefore the crosslinked binder network can be readily dissociated in basic condition, providing a facile strategy enabling valuable components recycled through a convenient washing method. The sulfur cathode prepared by the recycled carbon/sulfur composite can deliver comparable capacity as that of fresh electrode. In addition, evidence from cell performance and characterizations such as in-situ X-ray adsorption spectroscopy (XAS), in-situ UV-visible spectroscopy, X-ray photoelectron spectroscopy (XPS) and Density Functional Theory (DFT) calculation confirms that DICP is a more effective binder than its commercial counterpart on suppressing polysulfide dissolution in the electrolyte. Thus, this study provides an eco-efficient design to recycle valuable electrode materials demonstrated in Li—S cell configuration, which sheds lights on development of future circular economy such as large scale energy storage system.

In this work, a facile strategy is employed to recycle carbon/sulfur composite materials from cycled electrodes by utilizing a dissolvable ionic crosslinked polymer (named as DICP) binder. The three-dimensional network structure of DICP is formed by crosslinking polyacrylic acid (PAA) and polyethyleneimine (PEI) through carboxy-amino ionic interaction. This interaction is pH-controlled, and therefore, the crosslinking is readily dissociated in basic condition (i.e. aqueous sodium hydroxide or ammonium hydroxide solution), thus providing a plausible approach to recycle valuable electrode materials through a simple washing method based on water. The three-dimensional network structure of DICP significantly enhances mechanical integrity of carbon/sulfur composite for high sulfur loading electrodes formation. In addition, confinement of polysulfide intermediate species is realized through the strong affinity interaction with polar functional groups (i.e. amino and ammonium) within the DICP. Therefore, with the application of this robust binder, the Li—S battery could achieve excellent electrochemical performance, obtaining a high sulfur loading electrode of 5.5 mg cm⁻² with area areal capacity of 6.39 mAh cm⁻². The recycled carbon/sulfur composite could be re-fabricated into sulfur cathodes exhibiting approximately comparable capacity as that of fresh cathodes. To the best of knowledge, this is the first report of a recyclable Li—S batteries. The solvent employed in both the electrode preparation and the recycling processes is merely low-cost distilled water. This study provides an eco-efficient perspective for Li—S batteries recycling, a prospect that is closely germane to green chemistry and circular economy.

### Results and Discussion

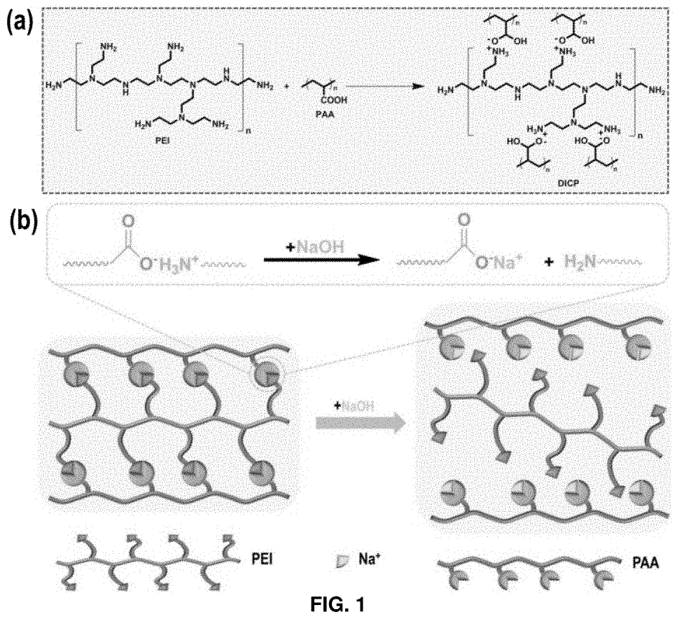

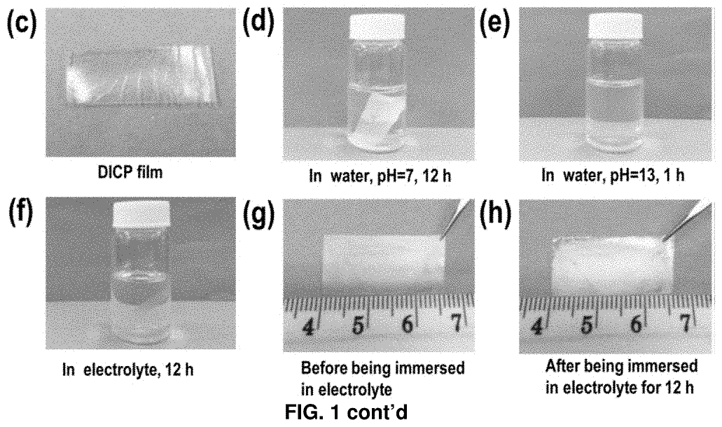

The design concept and synthesis schematic of DICP are displayed in FIG. 1 (Panel a), a three-dimensional network structure of DICP possessing abundant polar functional groups (i.e. amino and ammonium) is constructed by crosslinking PAA and PEI through the carboxy-amino ionic interaction. This interaction is pH-controlled in water, and therefore the crosslinked structure of DICP is easily destroyed and dissolved in basic aqueous solution (i.e. aqueous sodium hydroxide or ammonium hydroxide solution), as shown in FIG. 1 (Panel b). Upon casting the DICP solution (prepared in ammonium hydroxide solution) in PTFE mold, transparent DICP film was obtained (FIG. 1 (Panel c)). After being immersed in distilled water for 12 h, the DICP film turns white only and does not dissolve in water (FIG. 1 (Panel d)), indicating the formation of three-dimensional crosslinked network structure in DICP that is stable in distilled water. However, the film is dissolved completely in basic aqueous solution (pH=13) within 1 h, forming a homogeneous solution, indicating that the DICP film can be dissolved in basic aqueous. As shown in FIG. 1 (Panels f-h), after being immersed in electrolyte for 12 h, the DICP film does not dissolve without displaying any size variation, a phenomenon that indicates superior stability of DICP in electrolyte.

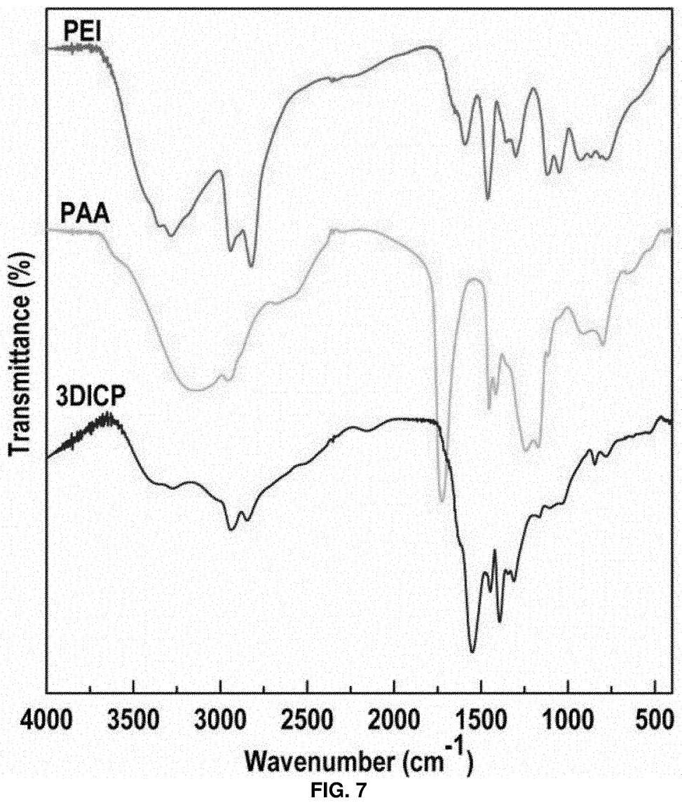

The chemical structure of DICP was confirmed by Fourier transform infrared (FTIR) spectroscopy and the results are shown in FIG. 7. The characteristic absorption peaks at 3349 cm⁻¹, 3281 cm⁻¹ 1649 cm⁻¹ 1592 cm⁻¹ and 1462 cm⁻¹ are attributed to the N—H stretching vibration in the spectrum of PEL^{[46]} The two peaks around at 2940 cm⁻¹ and 2822 cm⁻¹ correspond to the C—H stretching vibration of —CH₂—CH₂—.^{[46]} A broad absorption band at 3130 cm⁻¹ can be observed in the spectrum of PAA, corresponding to the O—H stretching vibration, whereas the strong peak at 1724 cm⁻¹ ascribed to the C═O stretching vibration in —COOH.^{[47]} Compared to the spectrum of PEI and PAA, the broad absorption band at 3130 cm⁻¹ for O—H stretching vibration disappears for DICP sample. The primary N—H stretching vibration of PEI at 3281 cm⁻¹ shifted to 3260 cm⁻¹, 1649 cm⁻¹ shifted to 1613 cm⁻¹, and C═O stretching vibration of PAA at 1724 cm⁻¹ shifted to 1548 cm⁻¹, as the result of the ionic interactions with the formation of carboxylic acid ammonium salt^{[48]} between PAA and PEI.

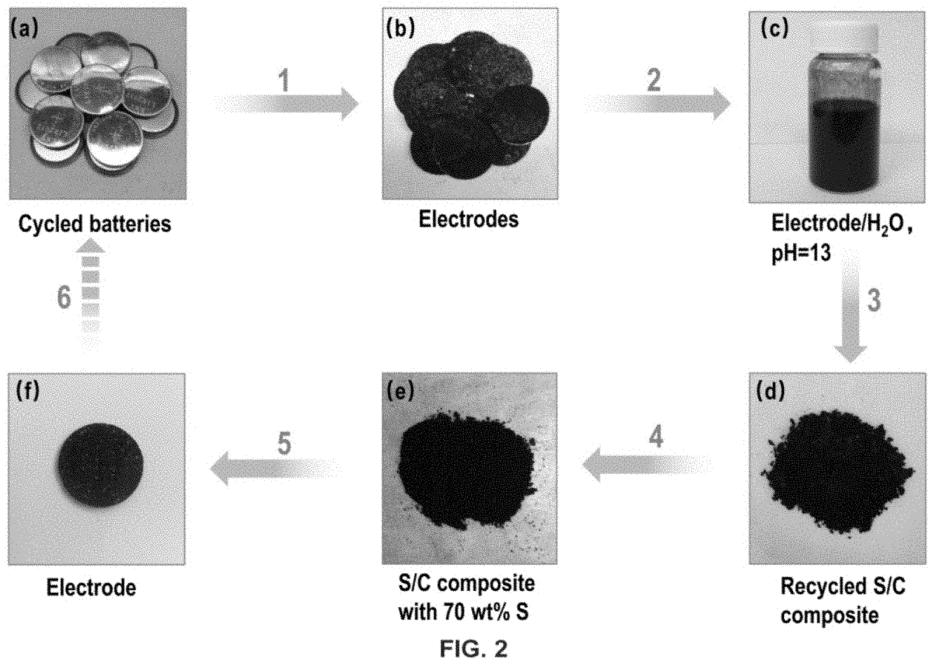

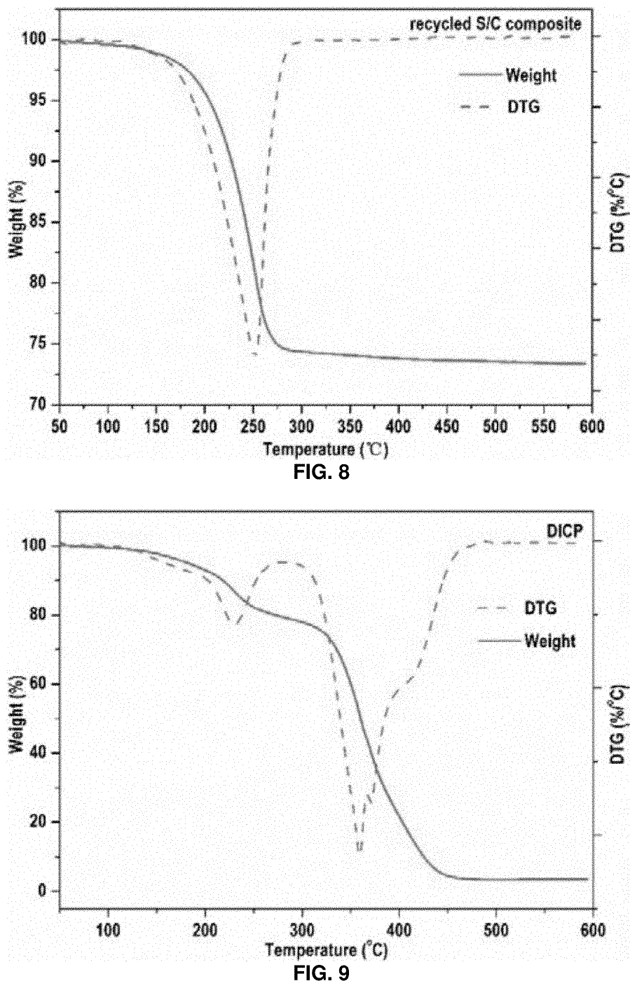

FIG. 2 shows the loop of electrode preparation and recycling process. The electrodes with sulfur loading around 5.0-6.0 mg cm⁻² were prepared by using DICP as binder and nickel foam as current collector, and the coin cells were assembled in Ar filled glove box (experimental details are shown in supporting information). After 100 cycles at 0.1 C (1 C=1675 mA g⁻¹), the Li—S cells were first disassembled in glove box to retrieve the cycled sulfur electrodes (FIG. 2 (Panel b)). Then, the collected electrodes were immersed into aqueous NaOH solution (pH=13) to dissociate the binder network. As shown in FIG. 2 (Panel c), the electrode materials were dispersed into water under continuous stirring condition. Afterwards, current collectors and mix solution were separated naturally without further steps. The recycled carbon-sulfur powder was obtained (FIG. 2 (Panel d)) by following washing (with distilled water)-centrifuging-drying (at 50° C. for 5 h) process. The amount of residual sulfur in recycled sulfur-carbon composite was confirmed by thermal gravimetric analysis (TGA). The TGA curve of recycled sulfur-carbon composite only shows one step weight loss in the temperature range of 130−300° C., corresponding to the loss of sulfur (FIG. 8). The detected weight loss of this step is about 25.7%. FIG. 9 reveals TGA curve of pure DICP, indicating the thermal decomposition process of DICP. However, no peaks can be assigned to the thermal decomposition of DICP in the temperature range of 300−450° C. in FIG. 8, suggesting no residual DICP in the recycled composite. Proper amount of sulfur powder was mixed with recycled S/C composite to compensate the sulfur loss during battery cycling (70 wt % final sulfur content) for next round of cycling. At the end, the new sulfur electrode was prepared in the same procedure introduced in the first step.

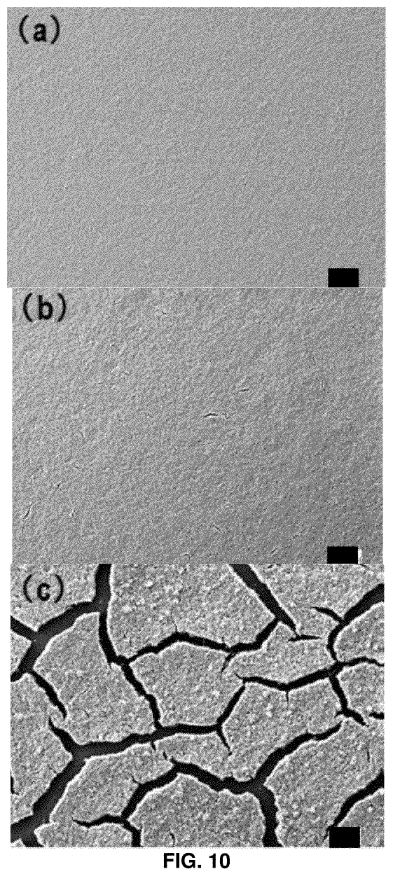

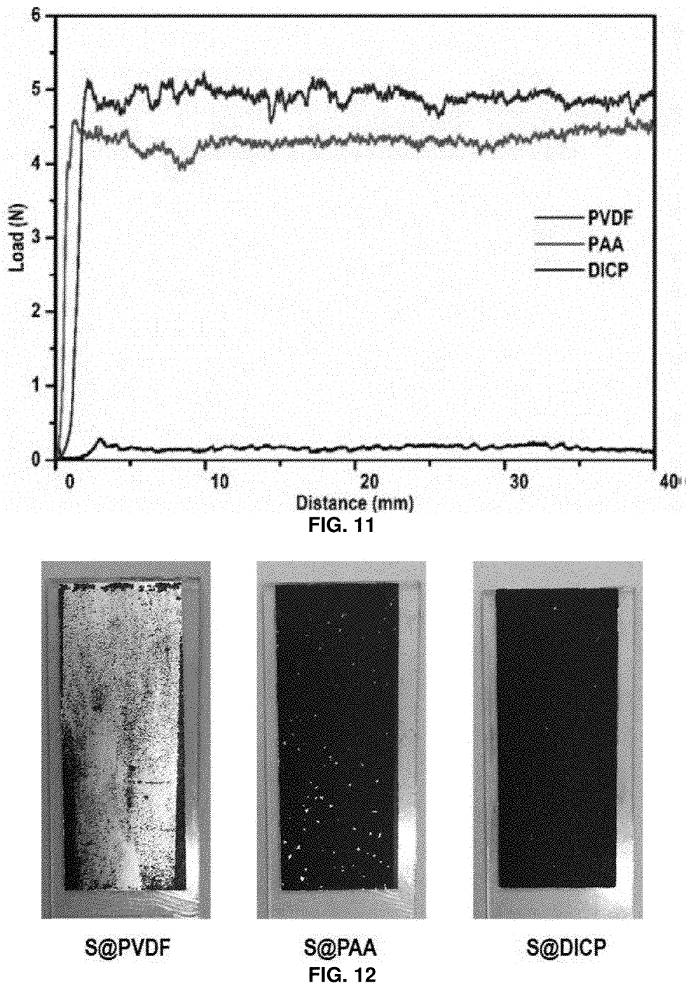

The top view scanning electron microscope (SEM) images of S@DICP, S@PAA and S@PVdF electrode are shown in FIG. 10. The electrode prepared with DICP binder exhibits a smooth surface, whereas S@PAA electrode displays a rough surface with fine fissure, and S@PVdF electrode shows evident cracks in the composite. The better electrode integrity of S@DICP electrode is contributed by the crosslinked network structure of DICP, which has strong mechanical capability to hold the sulfur-carbon composite together. The adhesion of binder is also of great benefits to the electrochemical performances of electrodes.^{[49]} Low adhesion leads to the loss of active material and degrades of conductivity, engendering continuous capacity fading and poor cycling stability. In order to evaluate the adhesion of DICP, peeling tests were conducted. As shown in FIG. 11, the S@DICP exhibits a superior peeling force, and no obvious material loss can be observed from S@DICP electrode. By contrast, the whole and a certain amount of electrode material was peeled off from current collector of S@PVdF and S@PAA electrode, respectively (FIG. 12), suggesting a much weaker adhesion strength of PAA and PVdF than that of DICP.

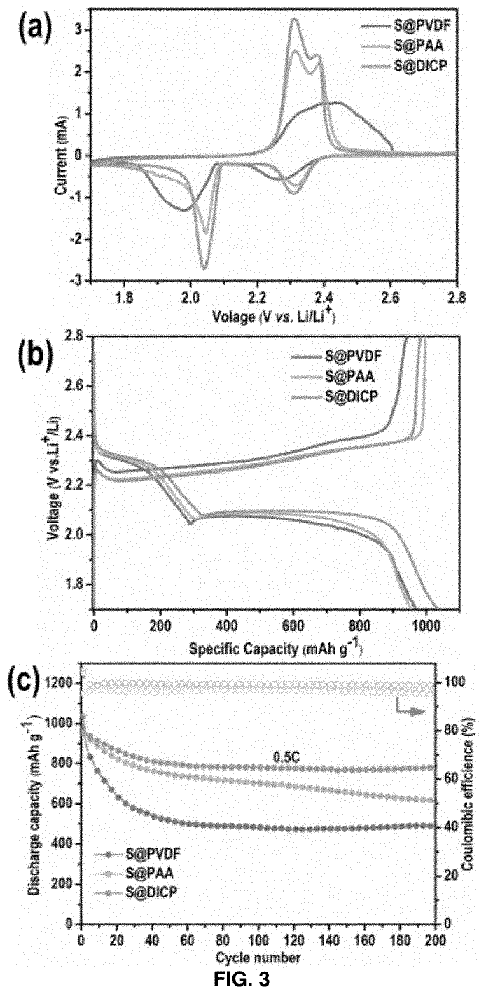

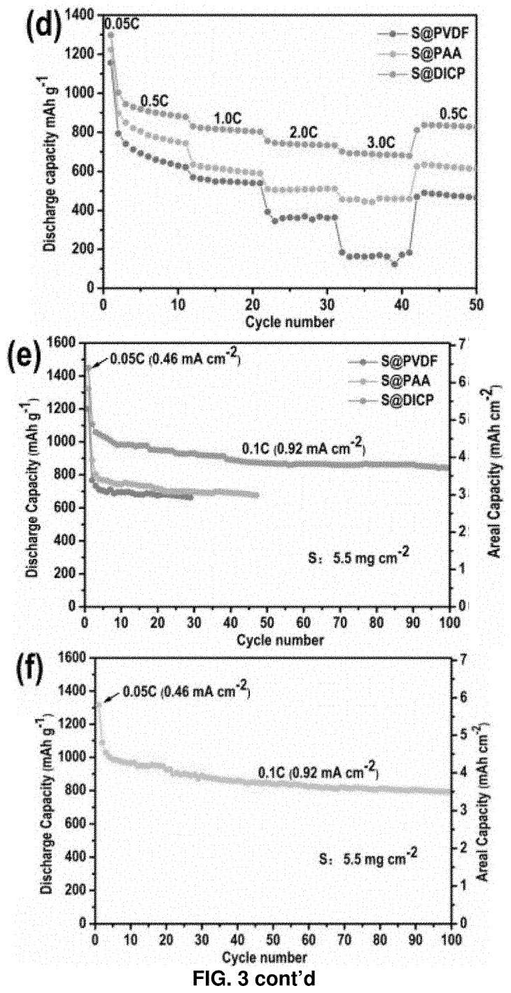

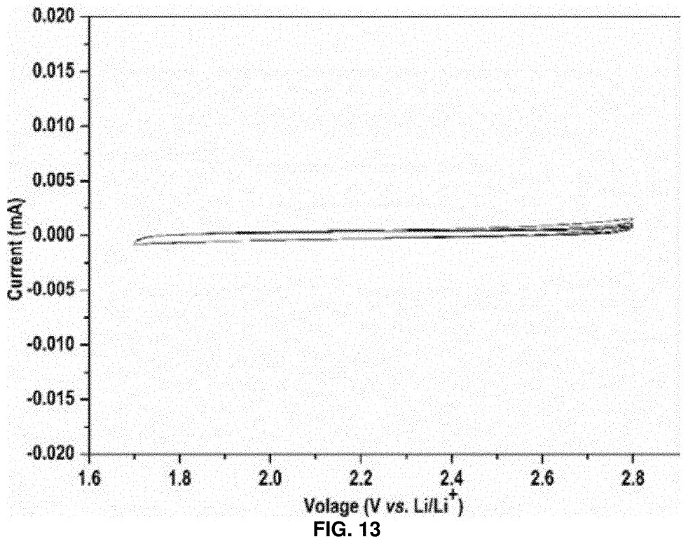

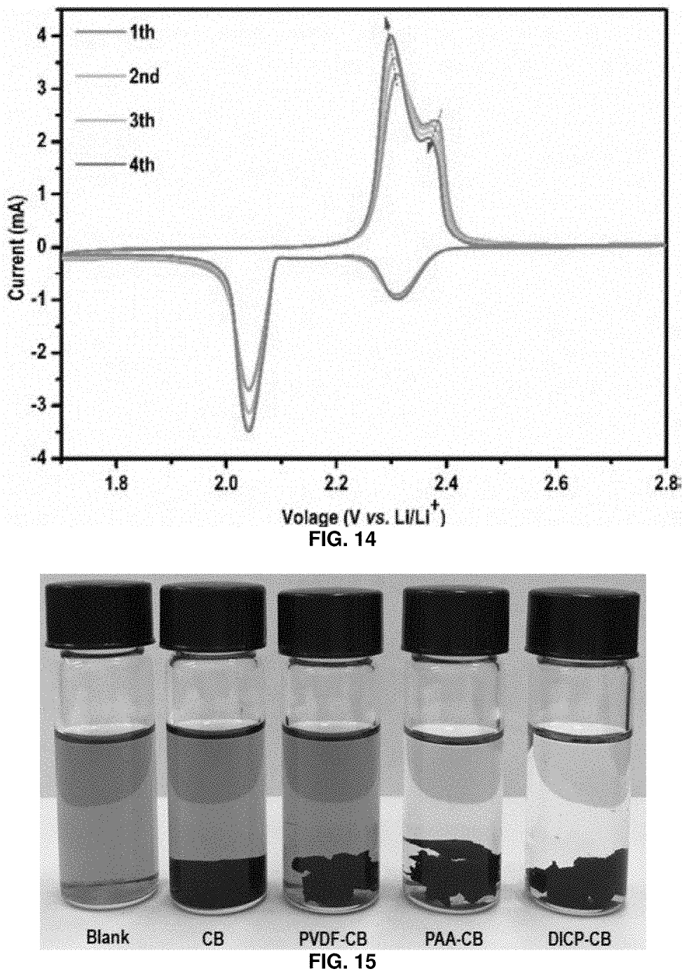

Electrochemical tests were conducted with the application of DICP, PAA and PVdF as binder for Li—S batteries. The electrochemical stability of DICP was first evaluated by cyclic voltammetry (CV). FIG. 13 demonstrates that the DICP is electrochemically stable in the voltage range from 1.7 to 2.8 V vs. Li/Li⁺. The CV curves of sulfur electrodes with different binders are shown in FIG. 3 (Panel a). The assembled Li—S cell was measured under the scanning rate of 0.1 mV s⁻¹ in the same voltage range (1.7-2.8 V). Two reduction peaks appear at 2.2-2.4 V and 1.8-2.1 Von the CV curve of S@DICP, S@PAA and S@PVdF electrode assembled Li—S cell, corresponding to the transition of elemental sulfur to long chain lithium polysulfide (Li₂Sₙ, 4≤n≤8), and further to low-order Li₂S₂/Li₂S, respectively. During the reverse scan of S@PVdF electrode, there is only one broad oxidation peak at 2.2-2.6 V can be assigned to the reverse transition from Li₂S₂/Li₂S to Li₂Sₙ (4≤n≤8) and further to elemental sulfur.^{[44,50]} Despite similar redox characteristic peaks, the S@DICP shows significantly reduction in voltage polarization in comparison with S@PVDF. Meanwhile, the CV peaks of S@DICP are much sharper than those of S@PVDF. All above differences confirm that the S@DICP, with favorable lithiation and delithiation during electrochemical reactions, profoundly enhances the reaction kinetics.^{[51]} As reported previously, the reaction kinetics can be affected by electrical conductivity and polysulfide/Li₂S affinity of host materials.^{[52}] Therefore, it can be concluded that the abundant affinity groups contained by DICP promote the charge transfer and intermolecular binding, accounting for the improved kinetics. With the further cycles of S@DICP (FIG. 14), the reduction peaks shift to the higher voltages, while oxidation peaks shift to the lower potentials, and redox peaks become slightly sharper, demonstrating the further decreased the polarization, which can be attributed to the strong absorption affinity of DICP towards polysulfides.^{[50]}

The first cycle discharge-charge profile (0.5 C) of S@PVdF, S@PAA and S@DICP electrodes are shown in FIG. 3 (Panel b). The voltage of discharge plateaus for S@DICP are higher, whereas the charge plateau is lower than that of S@PVdF and S@PAA. It suggests the enhancement of reaction kinetic. Therefore, in the first discharge stage, S@DICP delivers more capacity than that of S@PVdF and S@PAA, testifying that the transition of elemental sulfur to lithium polysulfides is more complete in S@DICP. When cycling at 0.5 C, S@DICP gives an initial discharge capacity of 1035 mAh g⁻¹; while the initial discharge capacity of S@PVdF and S@PAA is 979 mAh g⁻¹ and 954 mAh g⁻¹, respectively (shown in FIG. 3 (Panel c). After 200 cycles, the distinction is more evident. S@DICP delivers a discharge capacity of 780 mAh g⁻¹. In contrast, much lower capacity can be retained for S@PVdF and S@PAA. In addition to cycling stability at low rate, S@DICP also displays a superior rate performance. With retaining 701 mAh g⁻¹ at 3 C, discharge capacity exhibits 245 mAh g⁻¹ and 518 mAh g⁻¹ higher than that of S@PAA and S@PVDF, respectively (FIG. 3 (Panel d)). Such a superior cycling stability and high rate capability of S@DICP can be attributed to the chemical structural advantages (crosslinked network structures and large number of multifunctional polar groups) of DICP that maintain electrode's integrity and confine the lithium polysulfide within the cathode. These chemical structural benefits are more profound in high sulfur loading electrodes. In order to reach higher energy density than conventional batteries, the mass loading of sulfur electrode should be above 5.0 mg cm⁻².^{[53}] Therefore, sulfur electrodes with mass loading around 5.5 mg cm⁻² were prepared by using the nickel foam as current collect. As shown in FIG. 3 (Panel e), S@DICP electrode with high initial discharge capacity of 1448 mAh g⁻¹ equivalent to the area capacity of 6.39 mAh cm⁻² is obtained at current density of 0.05 C (0.46 mA cm⁻²), which is higher than that of S@PAA electrode (1323 mAh g⁻¹) and S@PVdF electrode (1200 mAh g⁻¹). When cycled at 0.1 C (0.92 mA cm⁻²), the S@DICP exhibits quite stable cycling performance. The discharge capacity can still reach to 841.7 mAh g⁻¹ after 100 cycles, corresponding to the 3.71 mAh cm⁻². By contrast, both S@PAA and S@PVdF cannot run more than 50 cycles even with much lower delivered capacity.

FIG. 3 (Panel f) shows the performance of Li—S cell assembled with recycled S@DICP electrode. The delivered discharge capacity and cycling stability are the same as the electrode prepared with pristine sulfur-carbon composite, as demonstrated in FIG. 3 (Panel e). The electrochemical result confirms that using DICP as binder not only enhance the sulfur loading and cyclic stability, the sulfur-carbon composite also can be successfully recycled from cycled Li—S cells via an environmentally friendly process.

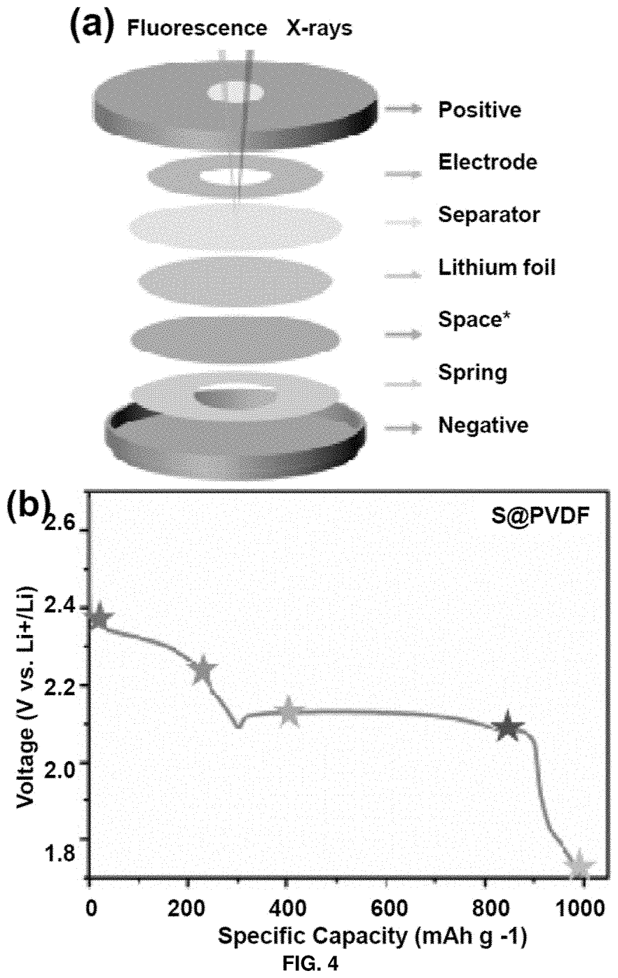

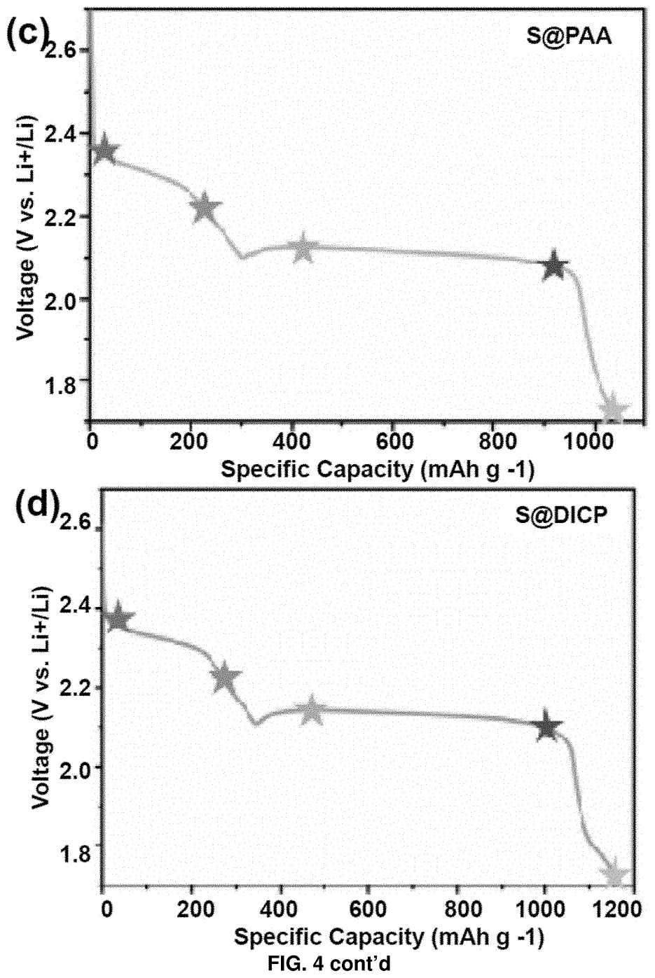

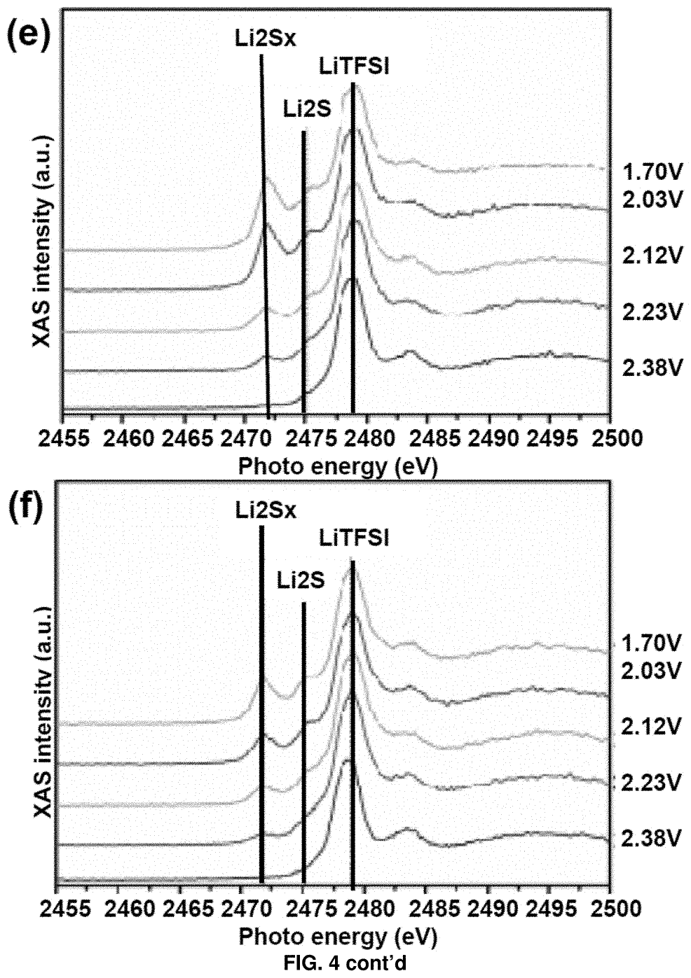

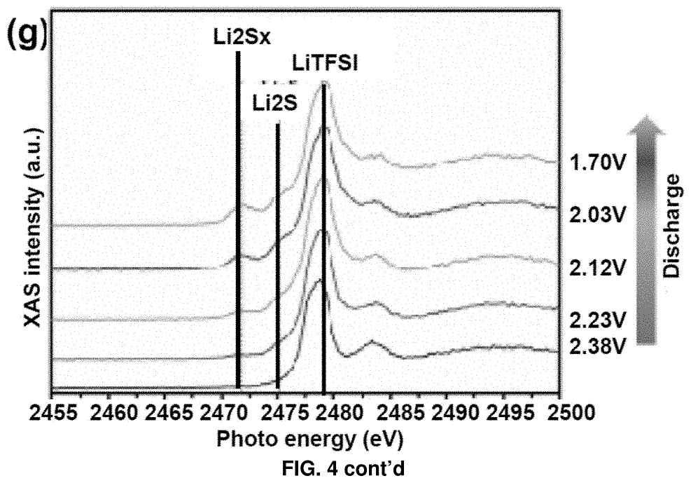

In order to gain insight of the confining capability of lithium polysulfides by different binders, in-situ X-ray adsorption spectroscopy (XAS) experiments were conducted to monitor the concentration variation of lithium polysulfides in electrolyte within coin cell (FIG. 4 (Panel a)). XAS spectra are selected when the voltage reaches to 2.38 V, 2.23 V, 2.13 V, 2.08 V and 1.70 V (Star pointed in FIG. 4 (Panels b, c and d) for S@PVdF, S@DICP and S@PAA electrode, as shown in FIG. 4 (Panels e-g). The strong peak at 2479.0 is ascribed to the sulfonyl groups in LiTFSI^{[13,54]}, and new peaks at 2471.8 eV and 2475.3 eV occurring during discharge process can be attributed to the formation of neutral sulfur (Li₂Sₓ and Li₂S), respectively.^{[55,56]} As for S@PVdF and S@PAA electrodes, the signal of Li₂Sₓ can be first detected when the voltage reach down to 2.23 V (green star point), indicating the dissolution of Li₂S₈ from cathode into the electrolyte started at this voltage stage.^{[18,54]} As the cell continuous discharged to 2.13 V (blue star point), the peak intensity of Li₂Sₓ obviously increased. It reached the maximum value when the voltage decreased to 2.08 V (purple star point), which verified that plenty of Li₂Sₓ released from cathode into electrolyte. In contrast, as for S@DICP, only a weak peak for Li₂Sₓ can be detected until voltage reached down to 2.14 V (blue star point) and peak intensity only slightly increased in the whole discharge process. The results suggested that the DICP binder can more efficiently confine the shuttle of lithium polysulfides than that of PVdF and PAA.

To investigate the adsorption capability of lithium polysulfide with different binders, same amount of Denka carbon black (CB) and different binder-CB composites (PVdF-CB, PAA-CB and DICP-CB) were added into the Li₂S₆-DME/DOL solution to compare the visual color changes. The color of Li₂S₆-DME/DOL solution after 12 h are shown in FIG. 15. The Li₂S₆ solutions exposed to PVdF-CB and PAA-CB still exhibit a typical orange color, which is similar to that of blank sample and solution with CB. In contrast, the solution exposed to the DICP-CB already become almost transparent, indicating strong adsorption of DICP to the lithium polysulfides. The strong adsorption capability of DICP to Li₂S₆ was further explored by using in-situ UV-vis spectroscopy. The absorption signal in the wave number range of 400-500 nm attributes to the Li₂S₆.^{[10,44]} During the whole test period, the intensity signal of Li₂S₆ solution exposed to DICP-CB composite shows a significantly higher decrease than that of PVdF-CB and PAA-CB. This clearly suggested that DICP can be stronger than PVdF and PAA in adsorbing lithium polysulfides. Owing to the strong adsorption capability of DICP, the shuttle effect of lithium polysulfide can be remarkably confined during battery cycling. As a result, the capacity is able to be well maintained even for long term cycle.

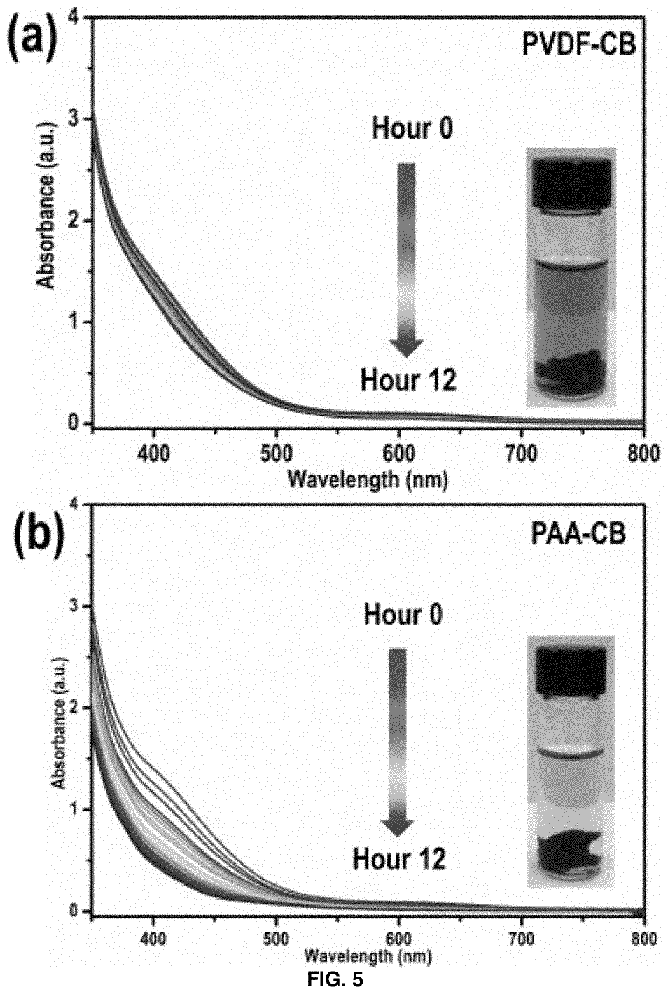

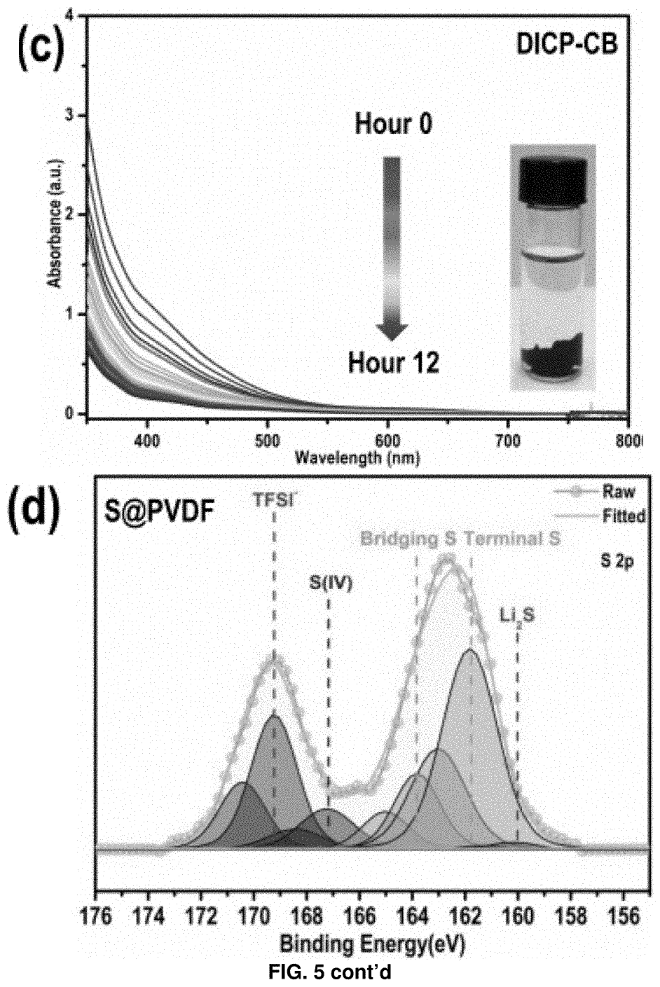

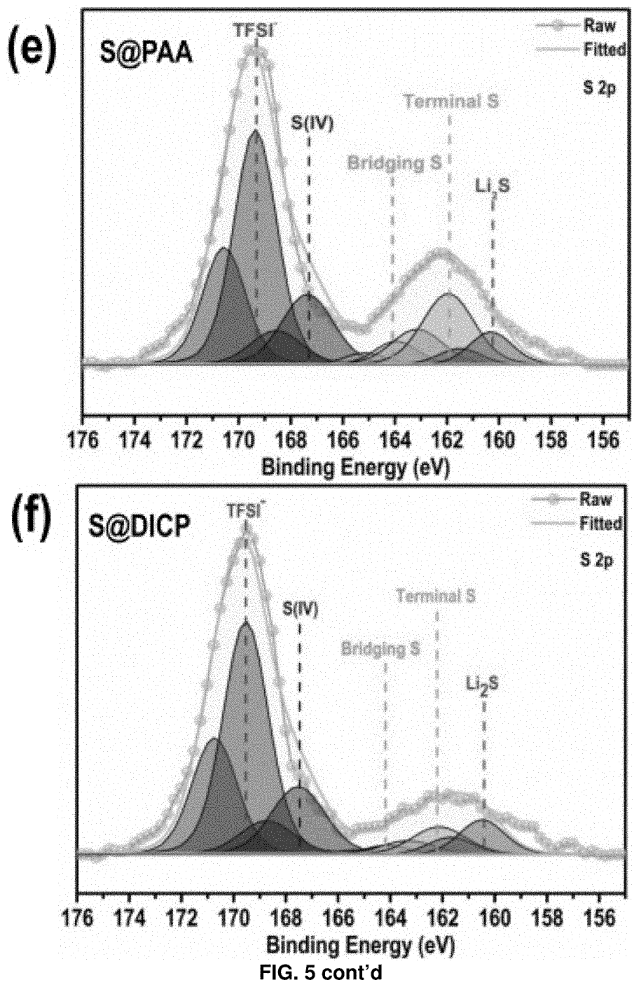

FIG. 5 (Panels d-f) show the X-ray photoelectron spectroscopy (XPS) analysis of the sulfur species formed on the surface of corresponding lithium anode. After ten cycles, the surface of lithium anode is covered by a variety of sulfur species. In FIG. 5 (Panel d), the peak at 169.3 is attributed to TFSI⁻ anion. The S 2p peaks split into two peaks (S 2p_{3/2} and S 2p_{1/2}) with a 2/1 intensity ratio and ˜1.2 eV binding energy differences.^{[57]} The small peak at lower binding energy of 167.3 eV can be assigned to the S(IV) degradation species of different sulfite salt, such as Li₂(F₃CSO₂—N—SO₂), LiSO₂CF₃ or Li₂SO₃.^{[58,59]} Another two components detected at lower binding energy of 163.8 eV (green) and 161.8 eV (orange) can be ascribed to the bridging sulfur and terminal sulfur atoms of Li₂Sₓ, respectively.^{[57,60]} Meanwhile, the signal of Li₂S is also observed at binding energy of 160.5 eV, which is derived from the reduction of polysulfides into Li₂S at the surface of lithium anode.^{[60]} The existence of lithium polysulfides on the surface lithium anode demonstrates that these species diffuse from sulfur cathode toward the lithium anode, causing the capacity fading. It is obviously that the signal intensity of lithium polysulfides of S@DICP (FIG. 5 (Panel f)) is lower than that of S@PVdF and S@PAA (FIG. 5 (Panel e)). This finding indicates high accordance with the previous results about in-situ XAS and in-situ UV-vis.

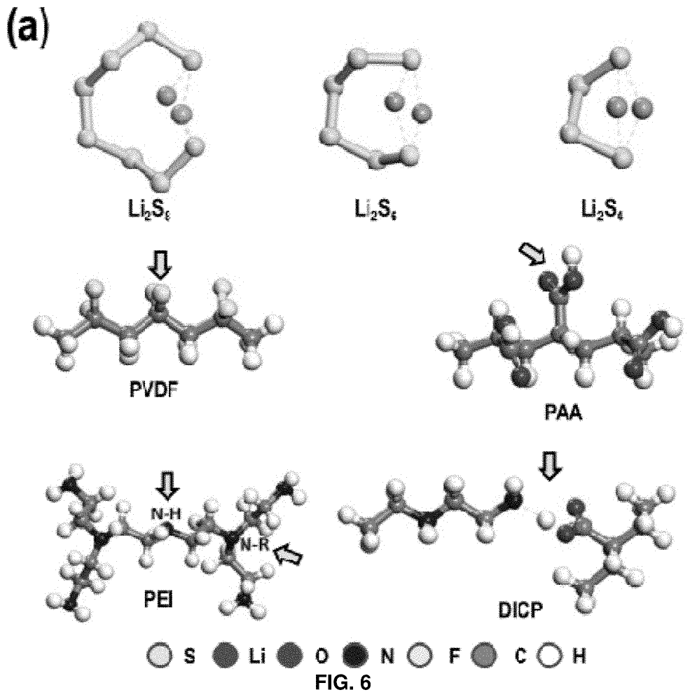

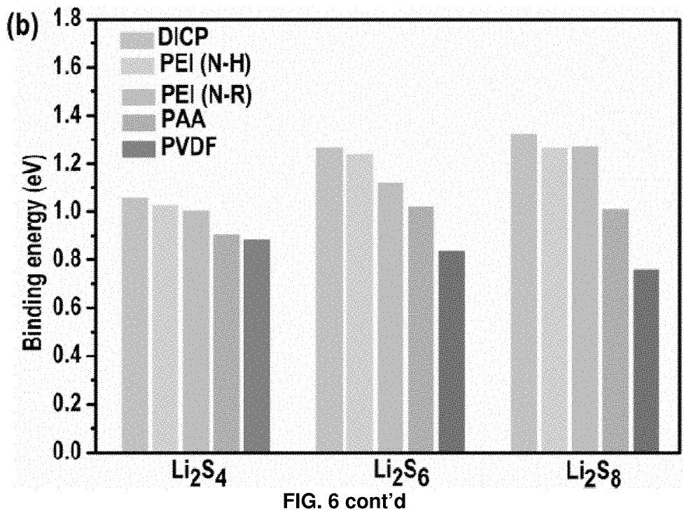

Density Functional Theory (DFT) calculation is utilized to simulate the confining capability for lithium polysulfides of different binders. Fragments of DICP, PEI, PAA and PVdF are employed to represent the structures of the polymer binders in the modeling process (FIG. 6 (Panel a)). Since only long-chain polysulfides are the most likely species to be dissolved in the electrolyte, Li₂S₈, Li₂S₆, and Li₂S₄ are chosen for this study. As shown in FIG. 6 (Panel b), the DICP exhibits higher binding energy with polysulfides, indicating the existence of stronger strength between polysulfides and DICP, which is consistent with the results performed by in-situ XAS, in-situ UV-vis and XPS. In addition, the advantage of DICP is more distinct for longer chain polysulfides. The binding energy of DICP to Li₂S₈ can reach up to 1.323 eV, which is much higher than the value for PAA (1.007 eV) and PVdF (0.7589 eV). Therefore, no Li₂S₈ can be detected from the in-situ XAS result of S@DICP when the cell discharges to 2.23 eV.

### 3. Conclusion

In conclusion, a novel DICP with multi-functional bonding groups as binder for Li—S batteries has been prepared through carboxy-amino ionic interaction using environment-friendly processes. The crosslinked network of DICP binder can be readily dissolved in basic condition, and therefore the sulfur/carbon composites are successfully recycled from cycled Li—S cells with a simple washing method based on water. In addition, re-fabricated Li—S cells are able to deliver the discharge capacity at the similar level to fresh materials. Meanwhile, through effectively confining the dissolution of lithium polysulfides and maintain integrity of electrode, DICP binder enables a high sulfur loading electrode of 5.5 mg cm⁻² with area areal capacity of 6.39 mAh cm⁻² can while preserving stable cycling stability. This study provides an eco-efficient perspective for preparing large scale batteries recycling, a guidance that is closely related to green chemistry and future circular economy.

### Experimental Section

### Materials

Polyacrylic acid (PAA, Mw=˜450000, Aldrich), polyethyleneimine (PEI, Mn=˜60000, 50 wt % in water, Aldrich), poly(vinylidene fluoride) (PVdF, Mw=˜534000, Aldrich), ammonium hydroxide solution (ACS reagent, Aldrich), sulfur (S₈ sublimed powder, reagent grade, Aldrich), Ketjen black carbon (EC-600JD, Akzo Noble Functional Chemicals LLC), Denka carbon black (Denka Co.), polypropylene separator (Celgard), 1-Methyl-2-pyrrolidinone (NMP, anhydrous, Aldrich), lithium bis(trifluoromethane) sulfonimide (LiTFSI, 98+%, Alfa Aesar), Lithium nitrate (Aldrich), 1,3-dioxolane (DOL, anhydrous, Aldrich), 1,2-dimethoxy ethane (DME, anhydrous, Aldrich) and sodium hydroxide (Aldrich) were commercially available and used as received without further purification.

The Fourier transform infrared spectroscopy (FTIR) measurements were conducted on an infrared spectrophotometer (Thermo Nicolet iS50) with 4 cm⁻¹ resolution averaged over 32 scans. Microstructure and morphology of active materials and electrode surface were investigated by using a scanning electron microscope (JEOL JSM-7500F). Thermogravimetry analysis of all samples was conducted on a thermal gravimetric analyzer (TGA, SDTQ600) from room temperature to 600° C. in a nitrogen atmosphere with a heating rate of 10° C./min. X-Ray Photoelectron Spectroscopy (XPS) spectra were measured with a PHI 5400 ESCA/XPS system with an Al Kα radiation (1486 eV) source.

### Experimental Procedure

### 1. Procedure for the Preparation of Reversible Ion Crosslinked Polymer (DICP) Solution and Film.

To a 250 ml one neck round bottom flask with a magnetic stir bar were added PAA (4.0 g) and H₂O (128.0 g) and stirred at room temperature until a homogeneous PAA solution was obtained. Ammonium hydroxide solution (20 g) was then drop added to the PAA solution via syringe. After stirring for 10 min, the mixture was further mixed with PEI solution (8.0 g) and stirred at room temperature for additional 30 min to obtain homogeneous DICP solution with solid content of 5 wt %. The DICP film was prepared by drying the DICP solution in a Teflon mold at 35° C. for 2 days and subsequently at 50° C. in vacuum oven for 12 h.

### 2. Electrode Preparation Process and Electrochemical Measurements

Sulfur/Ketjen black carbon composite (S/C composite) with a weight ratio of 7:3 was prepared in a sealed Teflon bottle by heating the pre-mixed sulfur and Ketjen black carbon at 155° C. for 15 h. To prepare the sulfur electrode, the slurry was prepared by mixing the S/C composite and DICP solution in distilled water (S/C composite:Denka carbon black:DICP=8:1:1) and ball-milling at 300 rpm for 12 h. The obtained slurry was then coated on the current collector with a common doctor-blade coating method, dried at room temperature for 5 h and further dried at 50° C. for 12 h. The prepared electrode was assembled CR2032 coin-type half-cells in an Ar-filled glove box by sandwiching the separator (Celgard 2400) between prepared electrode and metallic lithium wafer. 1.0 M LiTFSI in 1:1 (v/v) DOL/DME containing 1 wt % LiNO₃ was used as electrolyte (The electrolyte/sulfur ratios of Li—S batteries are around 20.0 uL mg⁻¹). For comparison sulfur electrode using PVdF and PAA as binder were prepared in the same processes, distilled water was used as dispersant for PAA, NMP for PVdF. The electrode using DICP, PAA and PVdF as binder is named as S@DICP, S@PAA and S@PVdF, respectively.

The galvanostatic battery test was conducted at 30° C. using a Maccor series 4000 cell tester between 1.7 V and 2.8 V. Cyclic voltammetry (CV) study of electrodes was conducted on a BioLogic instrument (MPG-200 series) in the potential range of 1.7-2.8 V with scan rate of 0.1 mV s⁻¹.

### 3. Peel Test

A sulfur cathode on aluminum foil with a width of 25.2 mm and a length of 50 mm was cut and attached to a glass plate. The 3 M adhesive tape was uniformly covered on the surface of electrode, and the peel strength of the cathode was measured with a tensile machine (TCD225 Series Digital Force Tester). The adhesive tape was moved by peeling at an angle of 180° at a constant displacement rate of 50 mm/min.

### 4. Preparation of Electrode for the In-Situ S K-Edge X-Ray Absorption Spectroscopy (XAS) Experiment and Measurement Method.

The in-situ sulfur K-edge XAS spectra were measured at beamline 5.3.1 at Advanced Light Source, Lawrence Berkeley National Laboratory. This is a bend magnet beamline with photon energy ranging from 1000 to 13,000 eV. The X-ray beam size is ˜100 μm×100 μm. The XAS spectra were collected in total fluorescence yield mode and calibrated using elemental sulfur spectra by setting the position of white line to 2472.2 eV. All the XAS spectra were measured under constant helium flow in the sample chamber and acquired continuously during the discharge process at a 0.1 C rate. The XAS spectra were background subtracted and normalized to the absorption pre- and post-edges. The cells used to perform in-situ and operando XAS experiments were adapted from the CR2032 coin cells: a 2×1 mm² hole was drilled at the sulfur (cathode) side of the can using a high precision laser system; the hole was then sealed with a 10-μm thick aluminum Mylar film to avoid leaking and allow X-ray beam penetration. To investigate the species evolution in the electrolyte during the discharge process, a 3×1.5 mm² hole was also drilled on sulfur cathode to make X-ray directly probe into the electrolyte.

### 5. In-Situ UV-Visible Spectroscopy (UV-Vis) Spectroscopy Test Method.

In-situ UV-vis spectroscopy was conducted by adding same amount of Denka black carbon (CB), different binder/CB composites with weight ratio of 2/8 (PVdF-CB, PAA-CB and DICP-CB) into the 3 ml Li₂S₆ in DOL/DME solution (1:1 v/v) to track the polysulfide concentration evolution for 12 h.

### 6. Density Functional Theory (DFT) Calculation Method.

The binding energies between lithium polysulfides and different polymer fragments were calculated using Density Functional Theory (DFT) as implemented in the Gaussian 09 package¹ with a hybrid functional B3LYP and the 6-311++g(d,p) basis set.^{2,3} In addition, van der Waals interactions within Grimme's parametrization (DFT-D3) and Becke-Johnson damping⁴ were considered in every case. Electrolyte (DME) solvation effects were implicitly described by a polarizable continuum model (SMD).^{5,6} Frequency calculations were performed to guarantee that the resulting structures were relaxed to their ground state. Zero-point energy corrections were also taken into account.

Fragments of PVdF, PAA, PEI, and DICP were modeled as representative structures of the polymer binders under investigation. In addition, only long-chain polysulfides: Li₂S₈, Li₂S₆, and Li₂S₄ were chosen since these species are the most likely to dissolve in the organic-based electrolyte used in this study.⁷ In each case, at least three different initial configurations—i.e., orientation of polysulfide with respect to the adsorption site/group—were considered for the polymer-Li₂Sₓ complexes. The final optimized configurations that led the most reasonable structures and lowest energies were selected to compute their respective binding energy. Polymer binder-polysulfide binding energies (E_{b}) were computed as follows:

E_{b}=E_{Poly}+E_{Li}_{₂}_{S}_{_{X}}−E_{Poly-Li}_{₂}_{S}_{_{X}}

where and E_{Poly}, E_{Li}_{₂}_{S}_{_{X}}, and E_{Poly-Li}_{₂}_{S}_{_{X}} are the energies of the polymer fragment, polysulfide, and binder-polysulfide complex, respectively. In order to provide an accurate description of the chemical binding strength of each polymeric binder in these simulations, polysulfides were aimed to interact with a single type of functional group, i.e., —F, —COOH, N—H (or N—R), and —NH₃OOC— for PVdF, PAA, PEI, and PEI-PAA, respectively.

References cited in Example 1 herein (which are all individually and specifically incorporated by reference):
[1] C. P. Grey, J. M. Tarascon, Nat. Mater. 2016, 16, 45.
[2] G. Harper, R. Sommerville, E. Kendrick, L. Driscoll, P. Slater, R. Stolkin, A. Walton, P. Christensen, O. Heidrich, S. Lambert, A. Abbott, K. Ryder, L. Gaines, P. Anderson, Nature 2019, 575, 75.
[3] T. Keijer, V. Bakker, J. C. Slootweg, Nat. Chem. 2019, 11, 190.
[4] J. Zhang, C. P. Yang, Y. X. Yin, L. J. Wan, Y. G. Guo, Adv. Mater. 2016, 28, 9539.
[5] M. Jana, R. Xu, X.-B. Cheng, J. S. Yeon, J. M. Park, J.-Q. Huang, Q. Zhang, H. S. Park, Energy Environ. Sci. 2020, DOI 10.1039/c9ee02049g.
[6] L. Kong, B. Q. Li, H. J. Peng, R. Zhang, J. Xie, J. Q. Huang, Q. Zhang, Adv. Energy Mater. 2018, 8, 1.
[7] X. Liang, C. Hart, Q. Pang, A. Garsuch, T. Weiss, L. F. Nazar, Nat. Commun. 2015, 6, 1.
[8] H. Li, Y. Tao, C. Zhang, D. Liu, J. Luo, W. Fan, Y. Xu, Y. Li, C. You, Z. Z. Pan, M. Ye, Z. Chen, Z. Dong, D. W. Wang, F. Kang, J. Lu, Q. H. Yang, Adv. Energy Mater. 2018, 8, 1.
[9] H. Lin, L. Yang, X. Jiang, G. Li, T. Zhang, Q. Yao, G. W. Zheng, J. Y. Lee, Energy Environ. Sci. 2017, 10, 1476.
[10] J. Song, Z. Yu, M. L. Gordin, D. Wang, Nano Lett. 2016, 16, 864.
[11] H. Al Salem, G. Babu, C. V. Rao, L. M. R. Arava, J. Am. Chem. Soc. 2015, 137, 11542.
[12] C. Fang, G. Zhang, J. Lau, G. Liu, APL Mater. 2019, 7, DOI 10.1063/1.5110525.
[13] L. Zhang, M. Ling, J. Feng, G. Liu, J. Guo, Nano Energy 2017, 40, 559.
[14] J. Song, M. L. Gordin, T. Xu, S. Chen, Z. Yu, H. Sohn, J. Lu, Y. Ren, Y. Duan, D. Wang, Angew. Chemie 2015, 127, 4399.
[15] Q. Zhang, H. Wan, G. Liu, Z. Ding, J. P. Mwizerwa, X. Yao, Nano Energy 2019, 57, 771.
[16] L. Du, Q. Wu, L. Yang, X. Wang, R. Che, Z. Lyu, W. Chen, X. Wang, Z. Hu, Nano Energy 2019, 57, 34.
[17] P. M. Shanthi, P. J. Hanumantha, T. Albuquerque, B. Gattu, P. N. Kumta, ACS Appl. Energy Mater. 2018, 1, 483.
[18] W. Chen, T. Lei, T. Qian, W. Lv, W. He, C. Wu, X. Liu, J. Liu, B. Chen, C. Yan, J. Xiong, Adv. Energy Mater. 2018, 8, 1.
[19] J. Liu, D. G. D. Galpaya, L. Yan, M. Sun, Z. Lin, C. Yan, C. Liang, S. Zhang, Energy Environ. Sci. 2017, 10, 750.
[20] X. Fu, L. Scudiero, W. H. Zhong, J. Mater. Chem. A 2019, 7, 1835.
[21] J. Liu, M. Sun, Q. Zhang, F. Dong, P. Kaghazchi, Y. Fang, S. Zhang, Z. Lin, J. Mater. Chem. A 2018, 6, 7382.
[22] F. Pei, T. H. An, J. Zang, X. J. Zhao, X. L. Fang, M. S. Zheng, Q. F. Dong, N. F. Zheng, Adv. Energy Mater. 2016, 6, 1.
[23] Z. Zhang, G. Wang, Y. Lai, J. Li, Z. Zhang, W. Chen, J. Power Sources 2015, 300, 157.
[24] W. Hu, H. Zhang, Y. Zhang, M. Wang, C. Qu, J. Yi, Chem. Commun. 2015, 51, 1085.
[25] G. Li, J. Sun, W. Hou, S. Jiang, Y. Huang, J. Geng, Nat. Commun. 2016, 7, DOI 10.1038/ncomms10601.
[26] Z. Zheng, H. Guo, F. Pei, X. Zhang, X. Chen, X. Fang, T. Wang, N. Zheng, Adv. Funct. Mater. 2016, 26, 8952.
[27] F. Pei, L. Lin, A. Fu, S. Mo, D. Ou, X. Fang, N. Zheng, Joule 2018, 2, 323.
[28] M. D. Patel, E. Cha, C. Kang, B. Gwalani, W. Choi, Carbon N. Y. 2017, 118, 120.
[29] S. K. Park, J. K. Lee, Y. C. Kang, Adv. Funct. Mater. 2018, 28, 1.
[30] D. Wang, A. Fu, H. Li, Y. Wang, P. Guo, J. Liu, X. S. Zhao, J. Power Sources 2015, 285, 469.
[31] S. K. Park, J. Lee, T. Hwang, B. Jang, Y. Piao, ACS Appl. Mater. Interfaces 2017, 9, 2430.
[32] C. Ye, L. Zhang, C. Guo, D. Li, A. Vasileff, H. Wang, S. Z. Qiao, Adv. Funct. Mater. 2017, 27, 1.
[33] Z. Li, H. Bin Wu, X. W. Lou, Energy Environ. Sci. 2016, 9, 3061.
[34] J. Cosmidis, A. S. Templeton, Nat. Commun. 2016, 7, DOI 10.1038/ncomms12812.
[35] H. Yuan, J. Q. Huang, H. J. Peng, M. M. Titirici, R. Xiang, R. Chen, Q. Liu, Q. Zhang, Adv. Energy Mater. 2018, 8, 1.
[36] H. Wang, V. Sencadas, G. Gao, H. Gao, A. Du, H. Liu, Z. Guo, Nano Energy 2016, 26, 722.
[37] Y. Jiao, W. Chen, T. Lei, L. Dai, B. Chen, C. Wu, J. Xiong, Nanoscale Res. Lett. 2017, 12, DOI 10.1186/s11671-017-1948-5.
[38] H. Chen, M. Ling, L. Hencz, H. Y. Ling, G. Li, Z. Lin, G. Liu, S. Zhang, Chem. Rev. 2018, 118, 8936.
[39] Q. Qi, X. Lv, W. Lv, Q. H. Yang, J. Energy Chem. 2019, 39, 88.
[40] N. Akhtar, H. Shao, F. Ai, Y. Guan, Q. Peng, H. Zhang, W. Wang, A. Wang, B. Jiang, Y. Huang, Electrochim. Acta 2018, 282, 758.
[41] X. Liu, T. Qian, J. Liu, J. Tian, L. Zhang, C. Yan, Small 2018, 14, 1.
[42] H. Ye, D. Lei, L. Shen, B. Ni, B. Li, F. Kang, Y. B. He, Chinese Chem. Lett. 2020, 31, 570.
[43] H. Zhang, X. Hu, Y. Zhang, S. Wang, F. Xin, X. Chen, D. Yu, Energy Storage Mater. 2019, 17, 293.
[44] W. Chen, T. Qian, J. Xiong, N. Xu, X. Liu, J. Liu, J. Zhou, X. Shen, T. Yang, Y. Chen, C. Yan, Adv. Mater. 2017, 29, DOI 10.1002/adma.201605160.
[45] Q. Pang, X. Liang, C. Y. Kwok, J. Kulisch, L. F. Nazar, Adv. Energy Mater. 2017, 7, 1.
[46] A. Kasprzak, M. Poplawska, M. Bystrzejewski, O. Łab [symbol] dź, I. P. Grudziński, RSC Adv. 2015, 5, 85556.
[47] Z. Xu, J. Yang, T. Zhang, Y. Nuli, J. Wang, S. ichi Hirano, Joule 2018, 2, 950.
[48] M. H. Ahmed, J. A. Byrne, J. A. D. McLaughlin, A. Elhissi, W. Ahmed, Appl. Surf Sci. 2013, 273, 507.
[49] G. Zhang, Y. Yang, Y. Chen, J. Huang, T. Zhang, H. Zeng, C. Wang, G. Liu, Y. Deng, Small 2018, 14, 1.
[50] M. Li, J. Zhou, J. Zhou, C. Guo, Y. Han, Y. Zhu, G. Wang, Y. Qian, Mater. Res. Bull. 2017, 96, 509.
[51] H. J. Peng, G. Zhang, X. Chen, Z. W. Zhang, W. T. Xu, J. Q. Huang, Q. Zhang, Angew. Chemie—Int. Ed. 2016, 55, 12990.
[52] T. Z. Hou, W. T. Xu, X. Chen, H. J. Peng, J. Q. Huang, Q. Zhang, Angew. Chemie—Int. Ed. 2017, 56, 8178.
[53] A. Bhargav, J. He, A. Gupta, A. Manthiram, Joule 2020, 1.
[54] M. Cuisinier, P. E. Cabelguen, S. Evers, G. He, M. Kolbeck, A. Garsuch, T. Bolin, M. Balasubramanian, L. F. Nazar, J. Phys. Chem. Lett. 2013, 4, 3227.
[55] X. Yang, X. Gao, Q. Sun, S. P. Jand, Y. Yu, Y. Zhao, X. Li, K. Adair, L. Y. Kuo, J. Rohrer, J. Liang, X. Lin, M. N. Banis, Y. Hu, H. Zhang, X. Li, R. Li, H. Zhang, P. Kaghazchi, T. K. Sham, X. Sun, Adv. Mater. 2019, 31, 1.
[56] M. Ling, L. Zhang, T. Zheng, J. Feng, J. Guo, L. Mai, G. Liu, Nano Energy 2017, 38, 82.
[57] M. Baloch, A. Vizintin, R. K. Chellappan, J. Moskon, D. Shanmukaraj, R. Dedryvère, T. Rojo, R. Dominko, J. Electrochem. Soc. 2016, 163, A2390.
[58] C. Xu, B. Sun, T. Gustafsson, K. Edstrom, D. Brandell, M. Hahlin, J. Mater. Chem. A 2014, 2, 7256.
[59] D. Aurbach, E. Pollak, R. Elazari, G. Salitra, C. S. Kelley, J. Affinito, J. Electrochem. Soc. 2009, 156, A694.
[60] C. Zu, Y. Fu, A. Manthiram, J. Mater. Chem. A 2013, 1, 10362.
[61] Frisch, M. J., et al., Gaussian 09, Gaussian, Inc.: Wallingford, Conn., USA, 2009.
[62] Becke, A. D., Density-functional thermochemistry. III. The role of exact exchange. J. Chem. Phys 1993, 98 (7), 5648-5652.
[63] Perdew, J. P.; Chevary, J. A.; Vosko, S. H.; Jackson, K. A.; Pederson, M. R.; Singh, D. J.; Fiolhais, C., Atoms, molecules, solids, and surfaces: Applications of the generalized gradient approximation for exchange and correlation. Phys. Rev. B 1992, 46 (11), 6671-6687.
[64] Grimme, S.; Ehrlich, S.; Goerigk, L., Effect of the damping function in dispersion corrected density functional theory. Journal of Computational Chemistry 2011, 32 (7), 1456-1465.
[65] Tomasi, J.; Mennucci, B.; Cammi, R., Quantum Mechanical Continuum Solvation Models. Chemical Reviews 2005, 105 (8), 2999-3094.
[66] Marenich, A. V.; Cramer, C. J.; Truhlar, D. G., Universal Solvation Model Based on Solute Electron Density and on a Continuum Model of the Solvent Defined by the Bulk Dielectric Constant and Atomic Surface Tensions. The Journal of Physical Chemistry B 2009, 113 (18), 6378-6396.
[67] Diao, Y.; Xie, K.; Xiong, S.; Hong, X., Insights into Li—S Battery Cathode Capacity Fading Mechanisms: Irreversible Oxidation of Active Mass during Cycling. Journal of The Electrochemical Society 2012, 159 (11), A1816-A1821.

It is to be understood that, while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

All patents, patent applications, and publications mentioned herein are hereby incorporated by reference in their entireties.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A polymer composition comprising a carboxylic acid-containing polymer (CP) and an amino-containing polymer (AP).

2. The polymer composition of claim 1, wherein the polymer composition is a liquid or aqueous mixture, wherein the CP and the AP are not linked to each other.

3. The polymer composition of claim 1, wherein the polymer composition is a solid, wherein the CP and the AP are ionic crosslinked to each other.

4. The polymer composition of claim 3, wherein the crosslink is via a plurality of carboxylic acid function groups of one or more CPs ionic linked to a plurality of amino functional group of one or more the APs through carboxy-amino ionic interaction.

5. The polymer composition of claim 1, wherein the AP comprises the following chemical structure: 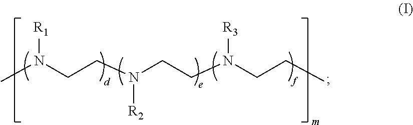
wherein R₁, R₂, and R₃ are each independently —H or —(CH₂)₂—NR₄R₅, wherein R₄ and R₅ are each independently —H, —(CH₂)₂—NH₂, or —(CH₂)₂—NR₄R₅; wherein the polymer chain can be terminated by —H, —(CH₂)₂—NH₂, or —(CH₂)₂—NR₄R₅; d+e+f=1; d, e, and f can be any number between 0 to 1; m is any number from about 10 or 100 to about 1000 or 10000; and. at least 1, 2, or 3 of R₁, R₂, and R₃ comprises a —NH₂ functional group.

6. The polymer composition of claim 5, wherein the AP is polyethyleneimine (PEI).

7. The polymer composition of claim 1, wherein the CP comprises the following chemical structure: 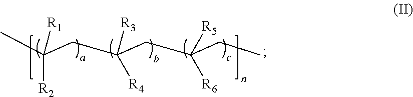
wherein R₁, R₂, R₃, R₄, R₅, and R₆ are each independently —H, —(CH₂)ₓ—CH₃, or —(CH₂)ₓ—COOH, wherein x is 0, 1, 2, 3, 4, or 5; wherein the polymer chain can be terminated by H or a functional group, such as a carboxylic acid; a+b+c=1; a, b, and c can be any number between 0 to 1; n is any number from about 10 or 100 to about 1000 or 10000; and. at least 1, 2, 3, 4, 5, or 6 of R₁, R₂, R₃, R₄, R₅, and R₆ comprises a —COOH functional group.

8. The polymer composition of claim 7, wherein the CP is a polyacrylic acid (PAA).

9. A lithium ion or lithium-sulfur battery comprising a binder comprising the polymer composition of claim 1.

10. The lithium ion or lithium-sulfur battery of claim 9, wherein the polymer composition prevents or suppresses polysulfide dissolution in the electrolyte of the lithium ion or lithium-sulfur battery.

11. A method of changing the state of the polymer composition of claim 1, the method comprising: (a) (i) introducing or adding a base to the polymer composition, wherein the AP and the CP are ionic crosslinked to other, to unlink the AP and the CP from each other, or (ii) introducing or adding an acid to the polymer composition, wherein the AP and the CP are not ionic crosslinked to each other, to crosslink the AP and the CP to each other.

12. The method of claim 11, wherein the method comprises the (a) (i) introducing step, and (b) introducing or adding an acid to the polymer composition to ionic crosslink the AP and the CP to each other.

13. The method of claim 11, wherein the method comprises the (a) (ii) introducing step, and (b) introducing or adding a base to the polymer composition to unlink the AP and the CP from each other.

14. The method of claim 12, wherein the (a) (i) introducing or adding a base to the polymer composition step comprises introducing or adding a base to the polymer composition to produce a solution having a pH of at least equal to greater than about 13 to unlink the AP and CP.

15. The method of claim 14, wherein the base is an alkali metal hydroxide, alkaline earth metal hydroxide, or a mixture thereof.

16. The method of claim 13, wherein the (a) (ii) introducing or adding an acid to the polymer composition comprises introducing or adding an acid to the polymer composition to produce a solution having a pH of at least equal to less than about 7 to ionic crosslink the AP and CP.

17. The method of claim 16, wherein the acid is an inorganic acid, organic acid, or a mixture thereof.
